(19) United States
(12) Patent Application Publication
(10) Pub. No.: US 2008/0102872 A1
(43) Pub. Date: May 1, 2008

(54) Downlink Power Control Method and Apparatus in the Distributed Antenna System

(76) Inventor: Sheng Liu, Guangdong (CN)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/599,531

(22) PCT Filed: Apr. 9, 2004
(86) PCT No.: PCT/CN04/00334

§ 371 Date: Jul. 20, 2007

(51) Int. Cl. H04B 7/00; H04Q 7/20

(52) U.S. Cl. 455/522

(57) ABSTRACT

The application discloses an apparatus for controlling downlink power of the complex cell in the centralized base station system based on remote radio frequency units, said base station system having a plurality of radio frequency unit and a RAKE receiver connected to said plurality of radio frequency units, the apparatus comprising: signal quality measuring means connected to the RAKE receiver, for measuring signal quality of an uplink channel between each radio frequency unit and the same user equipment; average signal quality calculating means for calculating average signal quality of each uplink channel according to the measured signal quality; and power control means for adjusting transmission power of the downlink channel corresponding to the uplink channel according to said average signal quality, so that the transmission power of the downlink channel corresponding to the uplink channel with a lower average signal quality is relatively lower.

### TECHNICAL FIELD

The present invention relate to the technical field of distributed base stations in a mobile communication system, and in particular to the downlink power control method and apparatus when using the complex cell technique in a centralized base station system based on remote radio frequency units.

### BACKGROUND TECHNOLOGY

As shown in FIG. 1a, a base station (BTS) performs transmission, reception and processing of wireless signals, and a conventional BTS is mainly composed by a baseband processing subsystem, a radio frequency (RF) subsystem and antennas, and one BTS may cover different cells through a plurality of antennas; And as shown in FIG. 1b, each BTS connects to the base station controller (BSC) or wireless networks controller (RNC) respectively through a certain interface, thereby constituting a wireless access network (RAN).

FIG. 2 present another kind of distributed base station, i.e., using the system architecture of a centralized base station based on remote radio frequency units. As compared to the conventional base station, such a centralized base station based on remote radio frequency units has many advantages: allowing to replace one macro cell based on the conventional base station with a plurality of micro calls, thereby best accommodating different wireless environments and increasing wireless performances such as capacity, coverage and etc. of the system; the centralized structure make it possible to perform the soft handoff in the conventional base station by a softer handoff, thereby obtaining an additional process gain; the centralized structure also makes it possible to use costly baseband signal processing resources as a resource pool shared by a plurality of cells, thereby obtaining benefits of statistical multiplexing and reduced system cost. More details of this technique are disclosed in PCT patent WO9005432 “Communications system”, U.S. Pat. No. 5,657,374 “Cellular system with centralized base stations and distributed antenna units”, U.S. Pat. No. 6,324,391 “Cellular communication with centralized control and signal processing”, China patent application CN1464666 “Soft base station system based on fiber optic stretch and synchronous method thereof”, China patent application CN1471331 “Base station system for mobile communication” and United States Patent application US20030171118 “Cellular radio transmission apparatus and cellular radio transmission method”.

As shown in FIG. 2, the centralized base station system based on remote radio frequency units are composed of a central channel processing subsystem and remote radio frequency units which are centralizedly configured and connected through the wideband transmission link or network. The central channel processing subsystem mainly comprises functional units such as the channel processing resource pool, the signal routing distribution unit and etc., wherein the channel processing resource pool is formed by stacking a plurality of channel processing units, and performs tasks such as baseband signal processing, and the signal distribution unit dynamically allocates channel processing resources according to the traffic of different cells to realize effective sharing of the processing resources among multiple cells. Besides the implementation inside the centralized base station as shown in FIG. 2, the signal routing distribution unit may also be implemented as a separate device outside the centralized base station. The remote antenna element is mainly constituted by functional units such as the transmission channel's radio frequency power amplifier, the reception channel's low noise amplifier, antennas and etc. The link between the central channel processing subsystem and the remote antenna element may adopt transmission medium such as optical fiber, coaxial cable, nicrowave and etc.; the signal transmission may be done by way of digital signals after sampling, or simulating signals after modulating; the signals maybe baseband signals, intermediate frequency signals or radio-frequency signals.

As noted earlier, in the centralized base station system based on remote radio frequency units, since it is allowed to use a plurality of micro cell to replace one macro cell based on the conventional base station, it is favorable for increasing the system capacity. Taking WCDMA (wideband code division multiple access) system as an example, in the uplink, the system capacity depends on the uplink interference, and by virtue of the uplink power control, UEs (user equipment) in each micro cell controlled by the centralized base station transmits a lower power, but with less interference on other micro cells, thereby increasing the uplink capacity than the macro cell; in the downlink, the system capacity depends on the maximal total downlink transmission power and the number of OVSF (orthogonal spreading factor) codes, and since the coverage of each micro cell controlled by the centralized base station considerably reduces as compared to the macro cell, the limitation by the power on the downlink capacity considerably reduces, and at the same time, since each micro cell has a different downlink scramble code, it is possible to allocate respective OVSF code resource to each micro cell, thereby solving the problem of limitation of the number of OVSF codes on the downlink capacity.

However, since the radius of the micro cell is small, as compared to the macro cell, it certainty results in a higher UE switching frequency, especially when the rate of movement of the UE is higher. The higher UE switching frequency will result in many potential problems: the call loss of the UE increases; the frequent radio measurement due to the switching increases the UE's power consumption, thereby reducing the UE's stand-by time; the excessive switching needs additional wireless resources, thus counteracting the increased system capacity by using micro cells. On the other hand, when the coverage area of the centralized base station system based on remote radio frequency units is lager, i.e., the number of micro cells under control is very large, the probability that its entire region reaches the peak capacity considerably drops, and therefore many cells do not exhibit high rate of capacity utilization, thus not actually obtaining the benefit of increased potential system capacity by using micro cells.

To this end, another patent application entitled “micro cell management method in the mobile communication system using the centralized base station”, which is filed at the same time with the present invention, propose a kind of effective solution for this problem: that is to say, dynamic cell control is performed for the cells under coverage according to the parameters such as the UE's moving speed, cell load conditions, processing resource occupation of the centralized base station, i.e., a plurality of geographically adjacent cells with the similar parameters are dynamically grouped into one cell, and in this dynamically generated cell, the downlink scramble code is the same, and the radio remote frequency units corresponding to the original micro cells forming the dynamic generated cell constitute a distributed radio frequency transceiver system of the dynamically generated cell. In addition, according to the patent application, it is also possible to employ a fixed configuration method to merge neighbouring micro cells into one cell, i.e., to fixedly configure the geographically adjacent micro cells in some areas into one cell according to the system configuration, and this is mainly suitable for the case where system design capacity is small at time of initial network construction. For the convenience of explanation, such a cell formed by dynamically or fixedly merging the geographically adjacent micro cells is called complex cell.

FIG. 3 is a schematic diagram showing the distributed transceiver scheme of the complex cell in the centralized base station based on remote radio frequency units. As shown in FIG. 3, micro cells #1-#7 are combined into one complex cell, which differs from the conventional cell by its distributed reception and transmission features. In the uplink direction, the remote radio frequency units in the micro cells all receive the uplink signals from the same user equipment (UE). Since the difference in geographic distribution between the remote radio frequency units, for the centralized base station, the uplink signals from the remote radio frequency units are equivalent to the multipath signals from the UE. Therefore, they can be correctly demodulated by the RAKE receiver. If a remote radio frequency unit is further from the UE, the signal received by it from the UE is certainty weaker. Since the base station RAKE receiver has the ability to automatically track and select multipath signals of strength higher than a certain threshold, in the uplink direction, stronger uplink signals from the closer UE are automatically selected, which is similar to the case of the cell with a single ordinary radio frequency unit.

In the downlink direction, however, all the remote radio frequency units in the complex cell transmit downlink signals to the same UE. For the remote radio frequency unit farther from the UE, its transmitted signal contributes very small to the UE's downlink receiving signal power, and therefore is unnecessary. On the other hand, the signal transmitted to the UE by the remote radio frequency unit farther from the UE may cause the interference by its downlink on other UEs, because the distributed transmission structure of the downlink signals actually generate a man-made multipath effect, thus reducing the orthogonality of the downlinks and deteriorating the performance of the downlinks

In view of this problem, the present invention is proposed.

### SUMMARY OF THE INVENTION

The object of the present invention is to provide an apparatus and method for controlling downlink power of the complex cell in the centralized base station system based on remote radio frequency units.

According to one aspect of the present invention, there is provided an apparatus for controlling downlink power of the complex cell in the centralized base station system based on remote radio frequency units, said base station system having a plurality of radio frequency unit and a RAKE receiver connected to said plurality of radio frequency units, the apparatus comprising: signal quality measuring means connected to the RAKE receiver, for measuring signal quality of an uplink channel between each radio frequency unit and the same user equipment; average signal quality calculating means for calculating average signal quality of each uplink channel according to the measured signal quality; and power control means for adjusting transmission power of the downlink channel corresponding to the uplink channel according to said average signal quality, so that the transmission power of the downlink channel corresponding to the uplink channel with a lower average signal quality is relatively lower.

According to another aspect of the present invention, there is provided a method of controlling downlink power of the complex cell in the centralized base station system based on remote radio frequency units, said base station system having a plurality of radio frequency unit and a RAKE receiver connected to said plurality of radio frequency units, the method comprising: measuring signal quality of an uplink channel between each radio frequency unit and the same user equipment according to the received signal measurement by the RAKE receiver; calculating average signal quality of each uplink channel according to the measured signal quality; and adjusting transmission power of the downlink channel corresponding to the uplink channel according to said average signal quality, so that the transmission power of the downlink channel corresponding to the uplink channel with a lower average signal quality is relatively lower.

According to the present invention, when using the complex cell technique in the centralized base station system based on remote radio frequency units, for a downlink directed to a certain UE, the remote radio frequency unit having less average downlink path lower will be selected to transmit the UE's downlink signals, and the UE's downlink signals transmitted from those remote radio frequency units with higher average downlink path loss will be switched off.

Actually, when a remote radio frequency unit is farther from the UE, the average downlink path loss of the path from the remote radio frequency unit to the UE is higher, and thus its transmission signal has less contribution to the power of the UE's downlink reception signals. Therefore, switching off the UE's downlink signals transmitted from the remote radio frequency units with higher average downlink path loss may not only save downlink power resources, but also effectively reduce the interference in the downlink direction. Contrarily, when a remote radio frequency unit is closer to the UE, the average downlink path loss from it to the UE is lower, and thus the power of the UE's downlink reception signals mainly comes from the remote radio frequency unit having lower average downlink path loss.

For a time division duplexing (TDD) system, the uplink and downlink path losses may be assumed to be equal. For a frequency division duplexing (FDD) system, since the uplink and downlink frequency bands are different, and the fast fadings of uplink and downlink channels are not correlative, the instant down path loss and the instant uplink path loss are different. However, since the uplink and downlink path losses averaged over a period of time are mainly dependent on the spatial distance of the propagation path, they are approximately equal.

Therefore, according to the present invention, it is possible to determine a relative magnitude of the path from each remote radio frequency unit of the complex cell to the UE according to the quality of uplink signal received by the remote radio frequency unit in the uplink direction from the UE, such as uplink signal strength, the uplink channel power received by the remote radio frequency unit from the UE, and the UE's uplink signal-interference ratio (SIR), and the relative magnitude may be used as a basis for judging whether each remote radio frequency unit should transmit the UE's downlink signal in the downlink direction.

### DESCRIPTION OF THE DRAWINGS

The present invention will be described by referring to the following accompanying drawings and embodiments, wherein:

FIG. 1a is a schematic diagram showing the structure of a conventional BTS;

FIG. 1b is a schematic diagram showing the structure of a wireless access network;

FIG. 2 is a block diagram showing the structure of a centralized base station system based on remote radio frequency units;

FIG. 3 is a schematic diagram showing the distributed transceiver scheme in the complex cell of the centralized base station based on remote radio frequency units;

FIG. 4 is a schematic diagram showing the structure of a spreading receiving device in the complex cell according to one embodiment of downlink power control device of the present invention;

FIG. 5 is a schematic diagram showing a merging unit for downlink physical channels in the prior art;

FIG. 6 is a schematic diagram showing a merging method for downlink physical channels of the present invention according to the embodiment;

FIG. 7 is a schematic diagram showing the structure of a spreading receiving device in the complex cell according to another embodiment of downlink power control device of the present invention; and

FIG. 8 is a schematic diagram showing a merging unit for downlink physical channels of the present invention according to another embodiment.

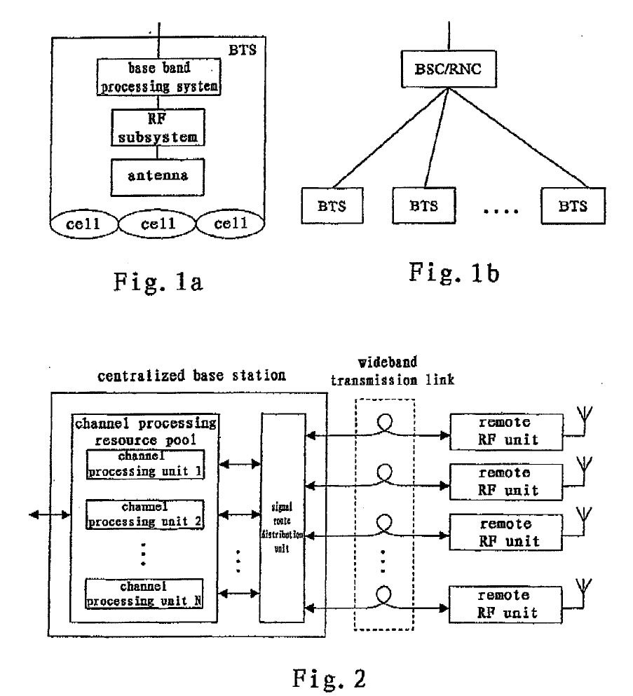

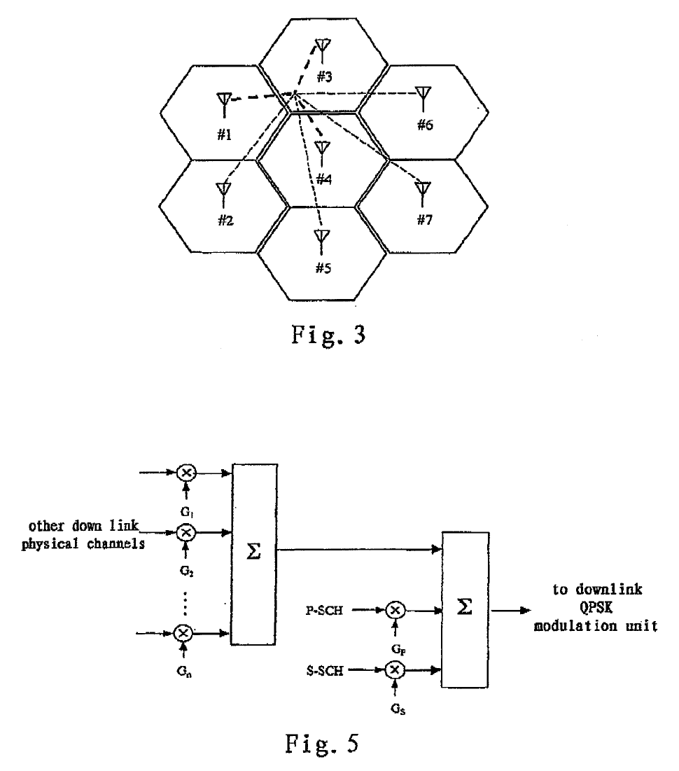

### DETAILED DESCRIPTION OF THE PREFERRED EMBODIMENTS

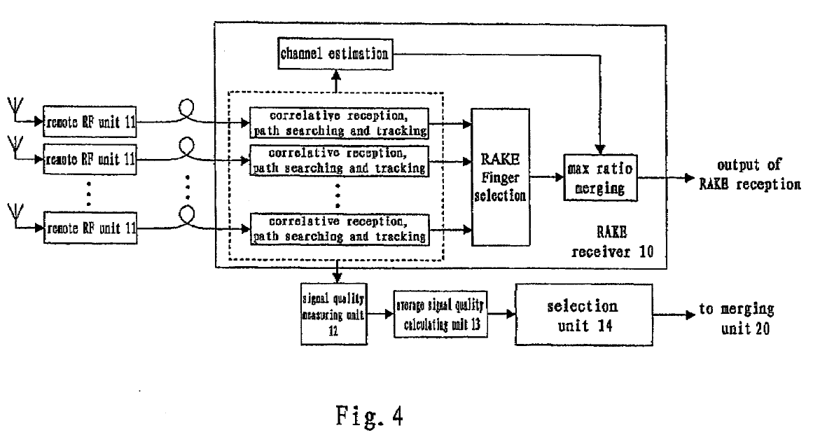

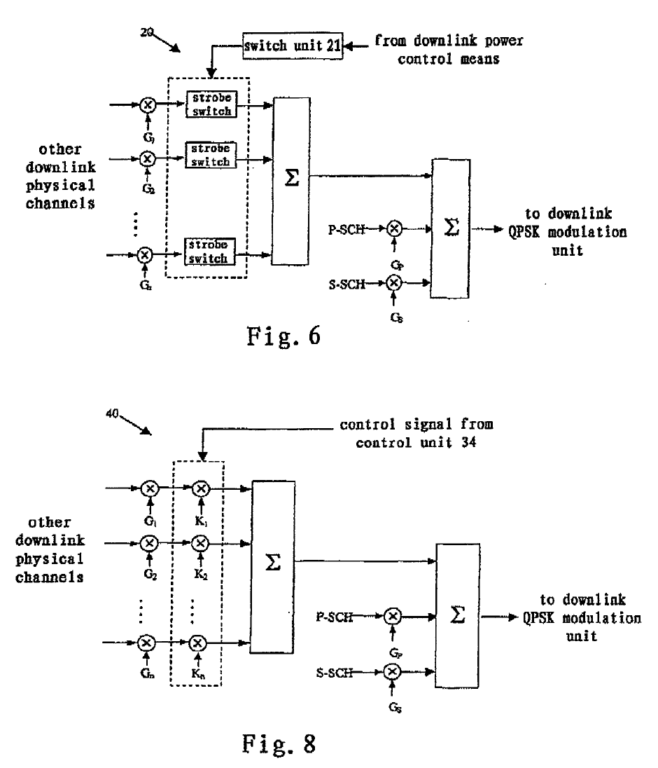

An embodiment of downlink power control device according to the present invention will be described by referring to FIGS. 4 and 6. FIG. 4 and 6 show a spreading reception device, a downlink power control device and a merging unit 20. For convenience of explanation, FIG. 4 only presents the spreading reception device corresponding to one UE. As shown in FIG. 4, the downlink power control device comprises a signal quality measuring unit 12, an average signal quality calculating unit 13 and a power control unit, wherein the power control unit comprises a selecting unit 14. As shown in the figure, the uplink reception signal from each remote radio frequency unit 11 of the complex cell is delivered to the centralized base station via a wideband transmission link for baseband processing. For the uplink, the spreading reception device of the complex cell is a receiving diversity RAKE receiver 10, where correlation reception, multipath searching and tracking processing are respectively performed on the signals of all the receiving branches. At the same time, the channel estimation processing is performed on each receiving branch, and finally the paths having strengths greater than a certain threshold are selected from all the receiving branches for max ratio merging. According to the present invention, the signal quality measuring unit 12 obtains the signal quality of a receiving branch corresponding to each remote radio frequency unit (such as signal intensity or code channel power or signal-interference ratio (SIR), wherein the signal intensity is a total signal level including the interference and noise component in the receiving branch, the code channel power is a useful signal power of the branch with the interference and noise component being removed, the SIR is a ratio of the code channel power and the interference and noise component) from the uplink diversity RAKE receiver 10. Then the average signal quality calculating unit 13 calculates a average signal quality (for example, average signal intensity or code channel Power or SIR) of each receiving branch over a period of time for cumulatively averaging. The selecting unit 14 determines the remote radio frequency unit branches having higher average signal intensity or code channel power or SIR for example by means of sorting, so as to use it for the control of downlink signal transmission power of the UE.

FIG. 5 shows a merging unit for downlink physical channels according to the prior art, more details of which is disclosed in technical specification TS25.213 of 3GPP (third generation cooperation project), wherein each remote radio frequency unit branch correspond to such a unit. As shown in the figure, instead of SCH (synchronous channel), other physical channels generated according to TS25.213 specification are synthesized into one way of signal after being respectively multiplied by a respective proportion factor, and then in delivered to the downlink QPSK modulating unit after being merged with the SCH channel. According to the present invention, as shown in FIG. 6, the downlink power control device further comprises a switching unit 21. Based on the merging unit as shown in FIG. 5, a strobe switch is added in front of each physical channel for controlling whether the corresponding physical channel should be transmitted. The gating signal for controlling each strobe switch is generated based on the selection for the remote radio frequency unit branch having higher average signal strength or code channel power or SIR, which is obtained from the uplink reception channel according to the present invention, that is to say, only the remote radio frequency unit branch having higher average signal strength or code channel power or SIR transmits the corresponding UE's downlink signal, which otherwise will not be transmitted in the remote radio frequency unit branch.

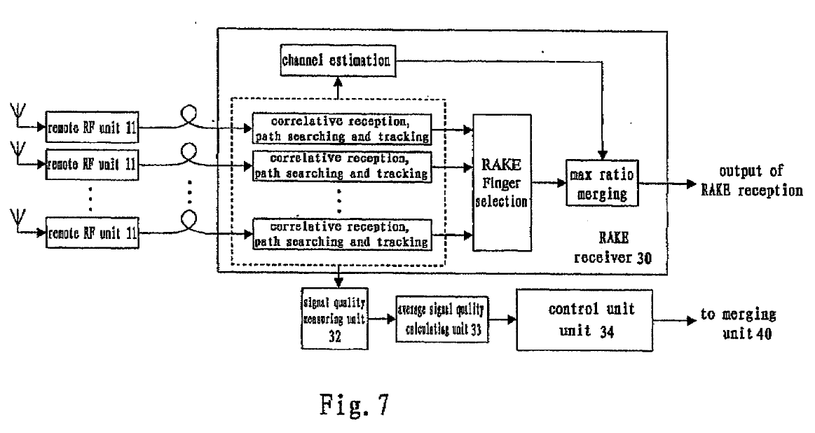

FIG. 7 and FIG. 8 show another embodiment of downlink power control device of the present invention. Differing from the above embodiment, as shown in FIG. 7, the embodiment's downlink power control device does not comprise the selecting unit and switching unit, but comprises a control unit 34 which determines a normalized power distribution proportion factor of each remote radio frequency unit branch based on the average signal strength or code channel power or SIR of each receiving branch, and uses it for downlink signal power proportion regulation of the UE corresponding to each remote radio frequency unit's downlink branch, as shown in FIG. 8. FIG. 8 shows a merging unit 40 where the power distribution proportion factor is controlled by the signal from control unit 34. In one preferable embodiment, the merging unit 40 may comprise a proportion control unit which actually the power distribution proportion factor based on the proportion determined by the control unit 34.

The following is a nonrestrictive example of the method of determining the normalized power distribution proportion factor for each remote radio frequency unit branch: if S₁, S₂, . . . S_{M} denotes the average signal strength or code channel power or SIR of each remote radio frequency unit branch obtained based on the present invention, wherein M is the number of remote radio frequency units (basic micro cells) in the complex cell, the normalized power distribution proportion factor Kᵢ, i=1,2, . . . M of each remote radio frequency unit branch say be found by using the following equation:

$${K}_{i} = \frac{{S}_{i}}{{\sum }_{m = 1}^{M} {S}_{m}} \qquad ( 1 )$$

In addition, the above two methods may be combined, where the remote radio frequency unit branch having higher average signal strength or code channel power or SIR is first selected, and the power distribution proportion factor of the UE corresponding to an unselected branch is set to zero. For the branch being selected to transmit the UE's downlink signal, the UE's normalized power distribution proportion factor is calculated based on the average signal strength or code channel power or SIR of the corresponding remote radio frequency unit branch.

For the convenience of describing the present invention, the present invention is described by taking the WCDMA system as an example. However, the basic spirit and method of the present invention are also applicable to other mobile communication systems based on CDMA technique such as CDMA2000, TD-SCDMA, UTRA TDD and etc.

1. An apparatus for controlling downlink power of the complex cell in the centralized base station system based on remote radio frequency units, said base station system having a plurality of radio frequency unit and a RAKE receiver connected to said plurality of radio frequency units, the apparatus comprising:
signal quality measuring means connected to the RAKE receiver, for measuring signal quality of an uplink channel between each radio frequency unit and the same user equipment;
average signal quality calculating means for calculating average signal quality of each uplink channel according to the measured signal quality; and
power control means for adjusting transmission power of the downlink channel corresponding to the uplink channel according to said average signal quality, so that the transmission power of the downlink channel corresponding to the uplink channel with a lower average signal quality is relatively lower.

2. The apparatus of claim 1, characterized in that said signal quality is signal intensity.

3. The apparatus of claim 1, characterized in that said signal quality is code channel power.

4. The apparatus of claim 1, characterized in that said signal quality is signal-interference ratio.

5. The apparatus of claim 1, characterized in that said average signal quality is calculated over a period of time such that the average path losses of uplink and downlink channels are substantially equal.

6. The apparatus of claim 1, wherein said base station system has a merging unit for merging downlink physical channels so as to be modulated by a downlink modulating unit, characterized in that said power control means further comprise means for controlling the merging unit's proportion factor for other downlink physical channel inputs than a synchronous channel, so that the proportion factor of physical channel of the downlink channel having lower uplink average signal quality is relatively lower.

7. The apparatus of claim 6, characterized in that said means for controlling the proportion factor performs said control by performing normalizing calculation on the average signal quality.

8. The apparatus of claim 1, characterized in that said power control means further comprises selecting means for comparing each average signal quality with a predetermined threshold, so that the downlink channel corresponding to the uplink channel with average signal quality below or equal to the threshold has transmission power of 0.

9. The apparatus of claim 8, wherein said base station system has a merging unit for merging downlink physical channels so as to be modulated by a downlink modulating unit, characterized in that said power control means further comprise switching means for switching off the corresponding input of the downlink channel, determined by the selecting means as having transmission power of 0, to the merging unit.

10. A method for controlling downlink power of the complex cell in the centralized base station system based on remote radio frequency units, said base station system having a plurality of radio frequency unit and a RAKE receiver connected to said plurality of radio frequency units, the method comprising:
measuring signal quality of an uplink channel between each radio frequency unit and the same user equipment according to the received signal measurement by the RAKE receiver;
calculating average signal quality of each uplink channel according to the measured signal quality; and
adjusting transmission power of the downlink channel corresponding to the uplink channel according to said average signal quality, so that the transmission power of the downlink channel corresponding to the uplink channel with a lower average signal quality is relatively lower.

11. The method of claim 10, characterized in that said signal quality is signal intensity.

12. The method of claim 10, characterized in that said signal quality is code channel power.

13. The method of claim 10, characterized in that said signal quality is signal-interference ratio.

14. The method of claim 10, characterized in that said calculating step comprise calculating the average signal quality over a period of time such that the average path losses of uplink and downlink channels are substantially equal.

15. The method of claim 10, wherein said base station system has a merging unit for merging downlink physical channels so as to be modulated by a downlink modulating unit, characterized in that said adjusting step further comprise controlling the merging unit's proportion factor for other downlink physical channel inputs than a synchronous channel, so that the proportion factor of physical channel of the downlink channel having lower uplink average signal quality is relatively lower.

16. The method of claim 15, characterized in that said step of controlling the proportion factor comprise performing normalizing calculation on the average signal quality.

17. The method of claim 10, characterized in that said adjusting step further comprises a selecting step of comparing each average signal quality with a predetermined threshold, so that the downlink channel corresponding to the uplink channel with average signal quality below or equal to the threshold has transmission power of 0.

18. The method of claim 17, wherein said base station system has a merging unit for merging downlink physical channels so as to be modulated by a downlink modulating unit, characterized in that said adjusting step further comprise a switching control step of switching off the corresponding input of the downlink channel, determined by the selecting step as having transmission power of 0, to the merging unit.
